(19) United States
(12) Patent Application Publication
(10) Pub. No.: US 2009/0037960 A1
(43) Pub. Date: Feb. 5, 2009

(54) Method and Apparatus for Acquiring Media Assets For Distribution to Subscribers in an On-Demand Media Delivery System Using a Peer-to-Peer File Transfer Protocol

(75) Inventor: Joel Melby, Southborough, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/831,269

(22) Filed: Jul. 31, 2007

(51) Int. Cl. H04N 7/173; G06F 15/16

(52) U.S. Cl. 725/87; 709/218; 709/231; 725/109; 725/91

(57) ABSTRACT

An on-demand system (e.g., a video on-demand system) includes a central network node on which reside media assets or programming available to subscribers upon request. A plurality of edge nodes is in communication with the central network node and with one another over a at least one packet-switched network. Each of the edge nodes includes at least one video on-demand server on which a subset of the available media assets reside. Each of the edge nodes is configured to provide on-demand services to subscribers in different geographic regions. The edge node also includes a content management agent for coordinating delivery of locally unavailable media assets from others of the edge nodes using a peer-to-peer file transfer protocol.

### FIELD OF THE INVENTION

The present invention relates generally to on-demand media delivery systems such as video on-demand media delivery systems for providing content to subscribers, and more particularly to an on-demand media delivery system in which the content is provided to subscribers from geographically distributed servers that acquire programming from one another using a peer-to-peer file transfer protocol.

### BACKGROUND OF THE INVENTION

A television may access programming content through a variety of transmission technologies such as cable, satellite, or over the air, in the form of analog or digital signals. Such programming may be delivered in accordance with a number of media delivery models including broadcast, multicast and narrowcast models. In addition to the aforementioned technologies, the Internet is emerging as a television content transmission medium. Television that receives content through an Internet network connection via the Internet Protocol (IP) may be generically referred to as IPTV. The Internet network may be the public Internet, a private network operating in accordance with the Internet Protocol, or a combination thereof. IPTV has become a common denominator for systems in which television and/or video signals are distributed to subscribers over a broadband connection using the Internet protocol. In general, IPTV systems utilize a digital broadcast signal that is sent by way of a broadband connection and a set top box (“STB”) that is programmed with software that can handle subscriber requests to access media sources via a television connected to the STB. A decoder in the STB handles the task of decoding received IP video signals and converting them to standard television signals for display on the television. Where adequate bandwidth exists, IPTV is capable of a rich suite of services compared to cable television or the standard over-the-air distribution.

Among other services, IPTV may offer on-demand services such as video on demand (VOD). A video on demand service permits a viewer to order a movie or other video program material for immediate viewing. In a typical video on demand system, the viewer is presented with a library of video choices. The VOD program material, such as movies, for example, are referred to herein as assets, programs or content. The viewer may be able to search for desired content by sorting the library according to actor, title, genre or other criteria before making a selection. In general, assets, programs and content include audio files, images and/or text as well as video.

In a typical VOD system, an application software component (known as the VOD client) resides in the set-top box (STB) at the viewer's home. A typical VOD system further includes a large number of service delivery points (e.g., VOD servers) throughout the network. The service delivery points store VOD content and generate the VOD video streams for subscribers. The video inventory in the VOD server may contain thousands of titles. As these inventories continue to grow it becomes more and more impractical to replicate the entire inventory at every service delivery point. Accordingly, some mechanism should be provided to intelligently place content in the network. Current systems often employ a central server on which the content is located. However, a central server, which is often located at the network headend, can create performance bottlenecks, present a single point of failure and can require extensive reconfiguring when new service delivery points are introduced.

### BRIEF DESCRIPTION OF THE DRAWINGS

FIG. 1 shows one example of an end-to-end network architecture for providing IPTV on-demand services from a super headend (SHE) to multiple end users.

FIGS. 2 and 3 show logical diagrams of a network architecture for storing and delivering on-demand assets to a subscriber or client.

FIG. 4 shows a series of edge locations that acquire media assets from one another using a peer-to-peer file transfer protocol.

FIG. 5 is a flowchart showing one example of a method that may be used by an edge device such as a VHO to delivery on-demand content to subscribers.

### DETAILED DESCRIPTION

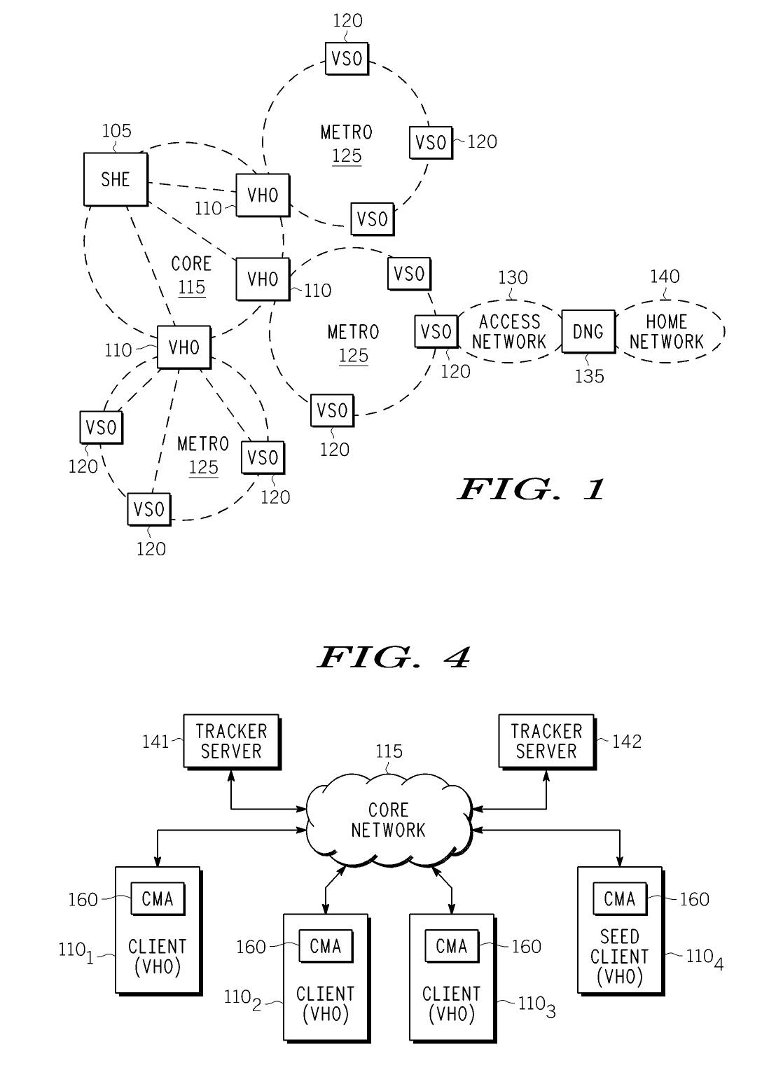

FIG. 1 shows one example of an end-to-end network architecture for providing IPTV on-demand services from a super headend (SHE) to multiple end users over one or more packet-switched networks. The topology employed in this example includes a three-level hierarchy: a large capacity core network, multiple metropolitan aggregation networks (configured as bidirectional rings in this example) and edge access networks. It should be emphasized that the network architecture shown in FIG. 1 is presented for illustrative purposes only. More generally, the techniques described herein are also applicable to other networks that include additional or fewer hierarchal levels, each of which may employ a wide range of different physical topologies including, but not limited to ring, tree, mesh and point-to-point networks. In addition, the various networks will generally include a variety of devices such as routers, gateways, bridges, ATM switches, frame relay switches, network management and control systems and the like, which are well-known components that need not be discussed in detail.

SHE 105 serves as a central (e.g., national) location for acquisition and aggregation of broadcast and on-demand programming as well as other content. The SHE 105 typically contains real-time encoders used for broadcast video service and asset distribution systems for on-demand services. The video hub offices (VHOs) 110 serve as distribution points for regional areas, each of which typically cover a demographic market area. The VHOs 110 include video servers that receive content from the SHE 105, acquire and encode additional local content, and insert local advertising into the programming. Video pumps are also provided in the VHOs 110 to supply content for on-demand services. In some implementations VHOs may serve a metropolitan area of between about 100,000 and 1 million residences. The SHE 105 communicates with VHOs 110 over the core network 115, which may be, for example, an IP backbone network.

Video Switching Offices (VSOs) 120 are essentially central offices that contain aggregation routers for distributing content received from the VHOs 110 to an access network. In some cases the VSOs 120 may include local video pumps that are used to cache popular on-demand content in order to reduce bandwidth requirements between the VSOs 120 and the VHOs 110. Depending on the nature of the access network, the VSOs 120 may also include, for example, digital subscriber line access multiplexers (DSLAMs) in the case of DSL access networks or optical line terminators (OLTs) in the case of fiber-based access networks. The VSOs 120 communicate with one another and the VHOs 110 over metropolitan aggregation networks 125, which may be, for example, gigabit Ethernet-based networks.

Access networks 130 provide the connectivity between the aggregation networks and a residential gateway 135 on the subscriber premises. Access network 130 may be, for example, a cable access network (e.g., coaxial network, HFC network), satellite network, broadband passive optical network (BPON), public-switched telephone network (PSTN) and the like. Residential gateway 135 provides traffic management and routing between the access network 130 and the subscriber's residential network 140. Residential gateway 135 may include a broadband modem such as a cable or DSL modem, for example, depending on the type of access network 130 that is employed.

As previously mentioned, the number of on-demand assets continues to grow at a rapid rate, thereby increasing the size of the content libraries residing at the SHE 105. As a result it becomes impractical to replicate all the available content at each of the VHOs 110. Accordingly, only the more popular on-demand content will reside at the VHOs 110 while less popular or so-called “long tail” content will reside only at the SHE 105. When a subscriber requests less popular on-demand content the SHE 105 rather than the VHO 110 will need to fulfill the request.

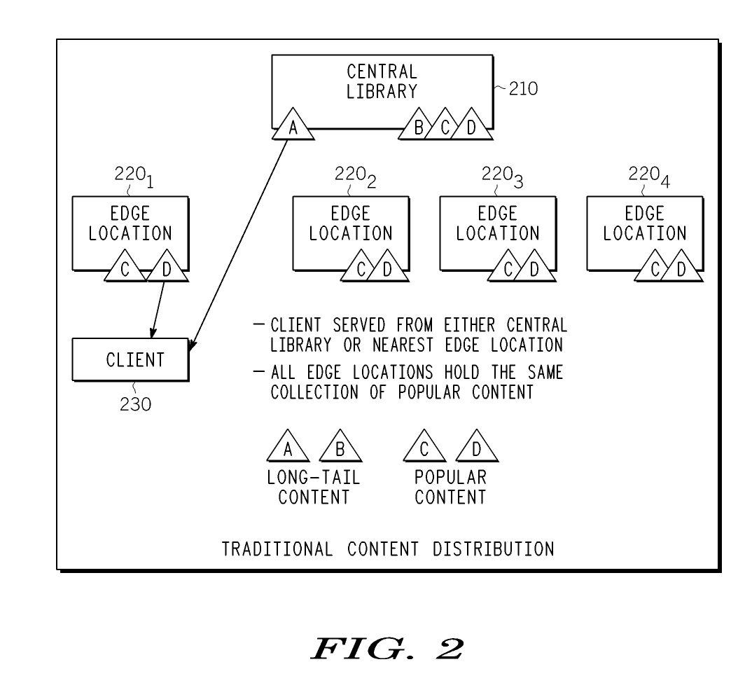

FIG. 2 shows a logical diagram of a network architecture for storing and delivering on-demand assets to a subscriber or client. As shown, a central library 210 serves as the primary location at which the assets or stored. In this example those assets are denoted as assets A, B, C and D. Some subset of the available assets, usually the more popular assets (in this case assets C and D) are replicated at each of the edge locations or service delivery points 220. Each edge location 220 distributes the assets among a select group of clients such as client 230. If the logical architecture of FIG. 2 is mapped onto the physical network architecture of FIG. 1, the central library 210 may correspond to SHE 105 and the edge locations 220 may correspond to the VHOs 110. As noted above, in a traditional on-demand asset distribution model of the type shown in FIG. 2, when a client requests less popular content such as asset A, for example, the asset is often supplied by central library 210 since it is unavailable at the edge location 220 associated with that client.

Alternatively, instead of using a traditional on-demand asset distribution model, the assets may be distributed as shown in FIG. 3. In this example, each edge location 220 only includes some of the popular assets instead of all the popular assets as in the example of FIG. 2. That is, the popular assets are not replicated at each and every edge location 220. In particular, edge locations 220₁ and 220₃ only includes asset C while edge locations 220₂ and 220₄ only include asset D. If in the example of FIG. 3 client 230 requests asset D from its edge location 220₁, instead of turning to the central library 210 for the asset, the edge location 220₁ could request asset D from another edge location using a peer to peer file transfer model, as described below. In addition to containing a subset of the more popular assets, each VHO 110 may also contain some of the less popular assets, which may be those assets particularly suited for the demographic market served by that VHO 110.

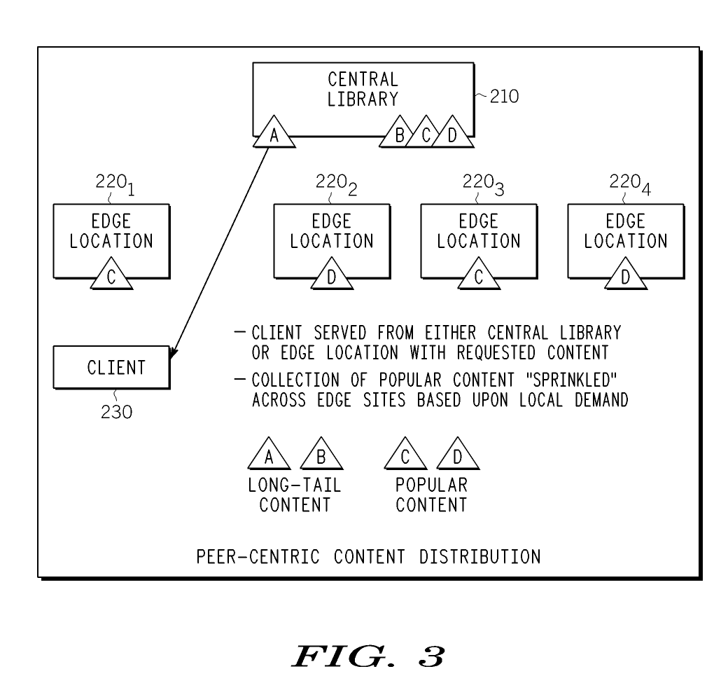

FIG. 4 shows a series of edge locations or service delivery points, which in this example are configured as the VHOs 110 of FIG. 1 interconnected over core network 115. The VHOs 110₁-110₄ can share assets among themselves using a peer to peer file transfer model, which is sometimes referred to as “cooperative distribution,” in which one or more VHOs that have previously downloaded a file can share the file with other VHOs. A cooperative distribution model allows a server to deliver large files in a reliable manner that scales with the number of requesting VHOs. Among other benefits, cooperative distribution models exploit the underutilized upstream bandwidth of existing VHOs. Current examples of peer-to-peer networks include systems such as BitTorrent, Kazaa, eDonkey, Gnutella, Direct Connect and the like.

In the BitTorrent file distribution system, for example, content files are divided into blocks or pieces and clients (e.g., the VHOs) attempt to find peers that together contain all of the blocks. When multiple clients are downloading the same file at the same time, the various clients upload blocks of the file to each other. In other words, a BitTorrent user trades blocks of a file that the client has with other required blocks that other clients have until the complete file is obtained. BitTorrent is designed to work better as the number of clients interested in a particular file increases, in contrast to other file transfer protocols where more clients tend to bog the system down. For illustrative purposes FIG. 4 will be described using the BitTorrent network protocol, although a wide variety of other peer to peer protocols may be employed, including, but not limited to, those mentioned above. Moreover, while in this example the VHOs are configured as the peer-to-peer clients that exchange assets, other network nodes alternatively may be configured in this manner, depending in part on the hierarchy of the nodes in the network and the role each node serves in storing and providing assets to the end user. For instance, in some cases the central office (e.g., VSOs in FIG. 1) may be the peer-to-peer clients.

The VHOs 110₁-110₄ may each include a content management agent (CMA) 160 to oversee and facilitate implementation of peer to peer file transfer among themselves. Among other things, the CMAs 160 may be used to organize selected ones of the VHOs into propagation groups. VHOs will generally only share assets with other VHOs in the same propagation group. The CMAs may use a multicast protocol to locate and identify one another and to organize into the propagation groups. When an asset is not locally available to a VHO 110, its CMA 160 may also be used to determine whether to have the asset sent to the subscriber from the central library (e.g., the SHE) or whether to obtain it from other VHOs in the same propagation group using a peer to peer file transfer protocol. For instance, the CMA 160 may determine that it is best for the central library to provide assets that are very infrequently requested, while assets that are requested more often than some threshold amount should be transferred to its own local library from other VHOs 110 using peer to peer file transfer.

In the case of the BitTorrent protocol, the CMA 160 also identifies one or more tracker servers, such as tracker servers 141 and 142, which coordinate the action of all the peer VHOs in the propagation group. The tracker server only manages connections and therefore a large number of VHOs can be supported with a relatively limited tracker bandwidth. The tracker server maintains lists of VHOs currently participating in the file sharing process for the desired asset. The CMA 160 selects one of the identified tracker servers to contact in order to procure a copy of the asset. The CMA 160 then establishes communication with the selected tracker server. The tracker server sends the CMA 160 a list of other peer VHOs that have or are currently downloading blocks of the asset that the VHO desires.

As an example, if VHOs 110₁ and 110₂ select tracker server 141, their respective CMAs 160 contact and communicate with the tracker server 141. The tracker program 150 then sends a network list back to each of the connecting VHOs 110₁ and 110₂. Included in the network list is contact information for at least one “seed” client, such as VHO 110₄, which has a full copy of the asset that the VHOs 110₁ and 110₂ wish to procure, as well as contact information for clients such as VHOs 110₁ and 110₂ that have recently contacted the tracker server 141 regarding the asset. The CMAs 160 of VHOs 110₁ and 110₂ then use the information in the provided network list to establish peer-to-peer communications with the VHO 110₄ and with one another in order to download the asset. The VHO connects to those peers (which will generally be located in the same propagation group) to obtain the various blocks of the asset. Such a group of peers connected to each other to share an asset is often called a swarm. If the swarm contains only the initial seeder, the VHO connects directly to it and begins to request blocks. As peers enter the swarm, they begin to trade blocks with one another, instead of downloading directly from the seed VHO.

Initially, the seed VHO 110₄ may be the only VHO in the peer-to-peer network that has any of the blocks available for delivery. When a block is successfully downloaded to one of the VHOs, however, the CMA 160 of that VHO announces to other VHOs that it now has a block available for downloading. As more VHOs join the peer-to-peer network along with the VHOs 110₁ and 110₂, this will further serve to speed up the distribution of the asset to all peer-to-peer VHOs in the propagation group as they participate in the swarm download. Eventually, all of the blocks of the asset may be available within the peer-to-peer network from peers other than the seed VHO 110₄. At that time, the seed VHO 110₄ may disconnect itself from the peer-to-peer network.

Before announcing the availability of an assembled block that has been downloaded, the CMA 160 can first verify that the assembled block is good. It does this, for example, by calculating a hash value for the assembled block and comparing the calculated hash value against a known hash value that has been previously provided. If the two hash values match, then the block is determined to be good. In this case, the other peer-to-peer VHOs are notified by the CMA 160 of the assembled block's availability for downloading. On the other hand, if the two hash values do not match, then the block is determined to be corrupted. In this case, the individual blocks for that assembled block are discarded and requested again from the same or different sources (i.e., other VHOs in the propagation group). As VHOs successfully download all blocks of the asset, they may disconnect from the peer-to-peer network. At the same time, other VHOs may be joining the peer-to-peer network to download the asset from remaining peers in the peer-to-peer network. In order to be notified of such newly joining VHOs, as well as to maintain its own contact information in the network list, it is useful for a VHO already participating in a swarm download to periodically re-connect to the tracker server and obtain an updated network list.

While in certain circumstances the BitTorrent protocol as described above may be suitable for acquiring assets from other VHOs, it suffers from certain deficiencies that make it less than ideal in other cases. For example, since pieces or blocks of the asset are provided to the VHO as they become available and not in sequential order, the VHO will need to obtain the complete asset before it can deliver it to a subscriber. Accordingly, the time the VHO needs to acquire the asset from its peers will generally be too great to satisfy a subscriber's on-demand request in real time. To overcome this problem the peer to peer file transfer protocol that is employed may advantageously support sequential piece transfer so that pieces of the asset are received in sequential order. In this way the VHO can begin to delivering the asset to the subscriber before it has been completely received by the VHO. Versions of BitTorrent, as well as other peer to peer file transfer protocols, which support sequential piece transfer are available.

Another potential deficiency of BitTorrent is its use of a tracker since downloads cannot be started if the tracker is down. Other peer to peer file transfer protocols, as well as some versions of BitTorrent itself, use a distributed cache to avoid the use of a tracker. In some cases these alternative protocols may prove beneficial.

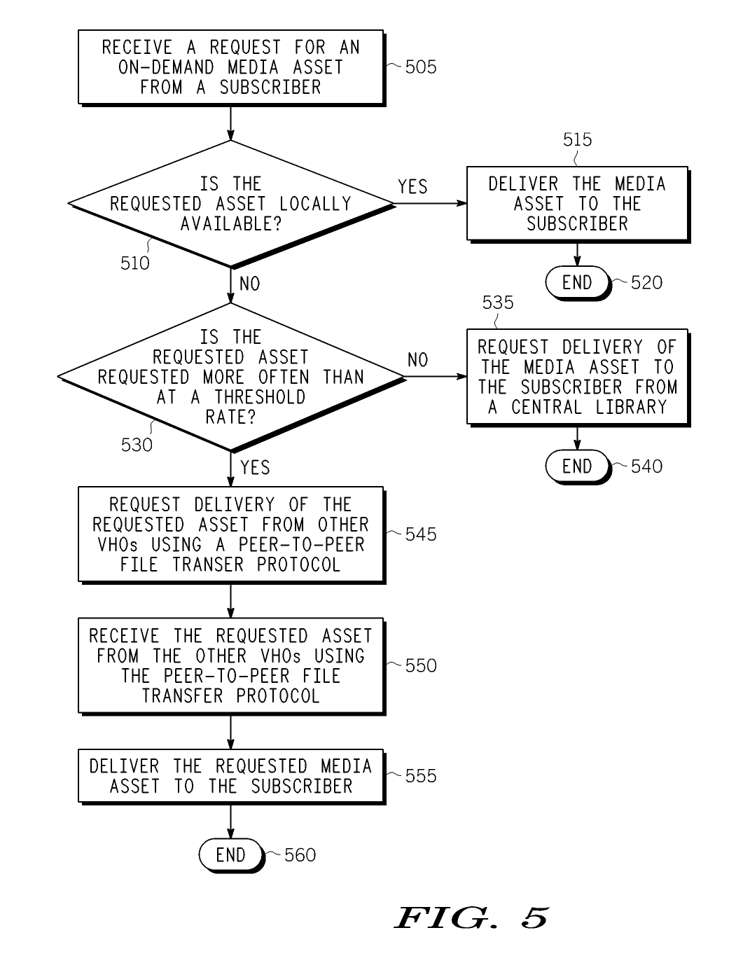

FIG. 5 is a flowchart showing one example of a method that may be used by an edge device such as a VHO to deliver on-demand content to subscribers. The method begins in step 505 when the VHO receives a request for an on-demand media asset from a subscriber. In response, the VHO determines if the requested media asset is locally available in step 510. If it is, then the VHO delivers the media asset to the subscriber in step 515 (over the access network and any intermediate networks) and the process terminates at step 520. On the other hand, if the requested media asset is not locally available, the VHO determines in step 530 if the asset is requested by one or more subscribers at a rate greater than some threshold rate. If the media asset is requested more often than at the threshold rate, the VHO in step 535 requests that the central library (e.g., super headend) deliver the asset to the subscriber, after which the process terminates at step 540. Alternatively, if the media asset is requested less frequently than at the threshold rate, the VHO requests delivery of the media asset from other VHOs in the same propagation group using a peer-to-peer file transfer protocol in step 545. In response, the VHO receives pieces of the media assets from one or more of the other VHOs using the peer-to-peer protocol in step 550. Finally, in step 555 the VHO delivers the requested media asset to the subscriber, after which the process terminates at step 560. If the peer-to-peer protocol employs sequential piece transfer, the VHO may begin delivering the media asset to the subscriber before all pieces thereof have been received.

The processes described above, including those shown in FIG. 5, may be implemented in a general, multi-purpose or single purpose processor. Such a processor will execute instructions, either at the assembly, compiled or machine-level, to perform that process. Those instructions can be written by one of ordinary skill in the art following the description of FIG. 3 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Although various embodiments and examples are specifically illustrated and described herein, it will be appreciated that modifications and variations are covered by the above teachings and are within the purview of the appended claims.

1. At least one computer-readable medium encoded with instructions which, when executed by a processor, performs a method including:
receiving from a subscriber terminal a first request for an on-demand media asset available from an on-demand media delivery system;
in response to the first request, requesting delivery of the asset from at least one edge location over a packet-switched network using a peer-to-peer file transfer protocol;
receiving the asset from the edge device in accordance with the peer-to-peer file transfer protocol; and
delivering the asset to the subscriber terminal over an access network.

2. The computer-readable medium of claim 1 wherein the peer-to-peer protocol employs sequential piece transfer and delivery of the media asset begins before all pieces thereof have been received.

3. The computer-readable medium of claim 1 wherein the edge location includes a video hub office (VHO) having at least one on-demand server that receives media assets from a super headend (SHE).

4. The computer-readable medium of claim 1 wherein, before requesting the delivery of the media asset from the edge location, further comprising determining that the requested media asset is not locally available and that the asset is requested less often than at a threshold rate.

5. The computer-readable medium of claim 4 wherein if a second media asset is requested more often than at the threshold rate, requesting that a central library provide the second media asset to the subscriber terminal.

6. The computer-readable medium of claim 5 wherein the central library is a super headend.

7. An on-demand system, comprising:
a central network node on which reside media assets available to subscribers upon request;
a plurality of edge nodes in communication with the central network node and one another over a at least one packet-switched network, each of the edge nodes including:
at least one video on-demand server on which a subset of the available media assets reside, each of the edge nodes being configured to provide on-demand services to subscribers in different geographic regions; and
a content management agent for coordinating delivery of locally unavailable media assets from others of the edge nodes using a peer-to-peer file transfer protocol.

8. The on-demand system of claim 7 wherein the content management agent is configured to determine if a locally unavailable media asset requested by a subscriber is to be provided by the central network node or acquired from the others of the edge nodes using the peer-to-peer file transfer protocol.

9. The on-demand system of claim 8 wherein the configuration manager requests that the central node provide the locally unavailable media asset if it is requested by subscribers more frequently than at a threshold rate.

10. The on-demand system of claim 7 wherein the content management agent is further configured to identify others of the edge nodes using a multicast protocol.

11. The on-demand system of claim 7 wherein the peer-to-peer file transfer protocol employs sequential piece transfer.

12. The on-demand system of claim 7 wherein the central network node is a super headend (SHE) and at least one of the edge nodes is a video hub office (VHO).

13. The on-demand system of claim 7 wherein the subset of available media assets residing on the edge nodes are media assets that are more frequently requested by subscribers than remaining ones of the available media assets residing at the central network node.

14. The on-demand system of claim 7 wherein different subsets of the available media assets reside on at least two of the edge nodes.

15. At least one computer-readable medium encoded with instructions which, when executed by a processor, performs a method including:
supplying on-demand programming to subscribers upon request over an access network;
receiving a request for delivery of an on-demand media asset from at least one edge location over a packet-switched network using a peer-to-peer file transfer protocol; and
supplying at least one piece of the requested on-demand asset to the edge location over the packet-switched network using a peer to peer file transfer protocol.

16. The computer-readable medium of claim 15 wherein the packet-switched network is an IP network.

17. The computer-readable medium of claim 15 wherein the on-demand programming is supplied from another edge location.

18. The computer-readable medium of claim 15 wherein the edge location includes a video hub office (VHO) having at least one on-demand server that receives media assets from a super headend (SHE).
